(19) United States
(12) Patent Application Publication
(10) Pub. No.: US 2005/0284800 A1
(43) Pub. Date: Dec. 29, 2005

(54) Apparatus for sorting particles

(75) Inventors: Yoichiro Handa, Atsugi-shi (JP); Yasuyuki Numajiri, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/165,249

(22) Filed: Jun. 24, 2005

(30) Foreign Application Priority Data
Jun. 28, 2004 (JP) 2004-190302

(51) Int. Cl. B07C 5/02

(52) U.S. Cl. 209/3.1

(57) ABSTRACT

An apparatus for sorting particles of multiple kinds having different properties in a fluid includes a flow channel for conveying the fluid containing the particles, multiple sorting regions provided in the flow channel for sorting the particles according to their properties, and sorting means provided in each of the sorting regions. The sorting means is capable of sorting particles having the same property by utilizing a difference in attraction force caused by a difference in property between particles.

### BACKGROUND OF THE INVENTION

1. Field of the Invention

The present invention relates to an apparatus for sorting particles. More specifically, the present invention relates to an apparatus/method for/of sorting multiple kinds of particles having different properties as well as a reagent, kit and detection apparatus/method for detecting a target substance in an analyte.

2. Related Background Art

With the increasing awareness of health problems and environmental problems as well as problems concerning safety in recent years, approaches to detecting trace amounts of biological and chemical substances involved in these problems have been desired. However, the recovery amounts of samples containing those biological and chemical substances (hereinafter, the substances may also be referred to as target substance) are limited, and a target substance in blood such as a protein is often present only in a trace amount in a complicated mixture of various substances. Therefore, measurement of the amount of such a substance requires high accuracy (repeatability) and high sensitivity, and accurate analyses with high reliability are also required.

Magnetic particles have been utilized for, for example, efficiently sorting and extracting a target substance present only in a trace amount in the complicated mixture of various substances.

U.S. 20020108889 A1 (Japanese Patent Application Laid-open No. 2002-233792) discloses a mechanism for sorting particles, including: means for generating an electric field or a magnetic field in a region having a flow channel through which a solution containing particles can flow in a direction across the flow channel to deflect the particles; and a particle capture portion for capturing the deflected particles to sort the particles.

Japanese Patent Application Laid-open No. 2002-503334 discloses an invention relating to a microflow system for sorting particles in which: a flow containing particles is controlled in such a manner that one particle passes through the cross section of a flow channel at one time; and a member is present in the flow channel and is placed in a field extending substantially perpendicular to the longitudianal axis of the flow channel in such a manner that particles to be affected by the field extending across the flow channel are deflected in the direction of the field. The document discloses that each particle is deflected in the direction of the field to be sorted.

With the above background art, a particle of a specific kind can be sorted from a fluid containing the particle of the specific kind and each particle in a mixture of multiple kinds of particles can be sorted. However, when a fluid contains multiple kinds of particles, it may be impossible to sort multiple particles of a specific kind at one time.

### SUMMARY OF THE INVENTION

The present invention has been made in view of the above background art, and an object of the present invention is to provide an apparatus for sorting particles capable of sorting multiple particles of a specific kind at one time from multiple kinds of particles in a fluid by providing multiple sorting regions.

Another object of the present invention is to provide an apparatus for detecting a target substance that captures a target substance different for each kind of particles having different properties and detects the target substance captured by the particle after sort of the particle by providing the particle to be sorted with a capture body that specifically captures the target substance.

According to the present invention, to attain the above object, there are provided the following apparatus/method for sorting particles.

That is, according to one aspect of the present invention, there is provided an apparatus for sorting particles of multiple kinds having different properties in a fluid, including a flow channel for conveying the fluid containing the particles, multiple sort regions provided in the flow channel for sort the particles according to their properties, and separation means for sorting particles having the same property by utilizing a difference in attraction force caused by a difference in property between particles, the sort means being provided in each of the sort regions.

According to another aspect of the present invention, there is provided a reagent for capturing a target substance in a sample, including multiple kinds of particles that can be collected according to their different properties, and a capture body provided on each surface of the particles for specifically capturing the target substance, in which the capture body captures a target substance specific for each of the multiple kinds having different properties.

According to another aspect of the present invention, there is provided a kit for detecting a target substance in a sample, including at least the reagent for capturing a target substance, and a capture body for recognizing the target substance with a label that can be optically detected.

According to another aspect of the present invention, there is provided an apparatus for detecting multiple target substances in a sample, including means for causing the reagent for capturing a target substance to capture a target substance in the sample, a flow channel for conveying the reagent and the sample, multiple sorting regions provided in the flow channel for sorting the particles according to their properties, sorting means for sorting particles having the same property by utilizing a difference in attraction force caused by a difference in property between particles, the sorting means being provided in each of the sorting regions, and means for detecting the amount of the target substance captured by the reagent for capturing a target substance in each of the sorting regions.

According to another aspect of the present invention, there is provided a method of detecting multiple target substances in a sample, including causing the reagent for capturing a target substance to capture a target substance in the sample; fixing particles having different properties in the reagent for capturing a target substance to different sorting regions according to their properties, and detecting the amount of the target substance captured by the reagent for capturing a target substance in each of the sorting regions.

According to another aspect of the present invention, there is provided a method of sorting multiple particles having different properties in a fluid, including conveying the fluid containing the particles at a constant flow rate, and sorting particles having the same property by utilizing a difference in attraction force caused by a difference in property between particles to thereby sort the particles according to their properties.

According to the present invention, multiple sorting regions are provided, whereby multiple particles of a specific kind can be sort at one time from multiple kinds of particles in a fluid.

According to the present invention, a capture body for specifically capturing a target substance to a sorted particle is provided, whereby a target substance different for each kind of particles having different properties can be captured. Furthermore, according to the present invention, after particles have been sorted through the capturing of a target substance, it becomes possible to detect whether a target substance is captured by a particle in each sorting region.

### BRIEF DESCRIPTION OF THE DRAWINGS

FIGS. 1A, 1B, and 1C are explanatory views showing various kinds of magnetic particles to be used in the present invention;

FIG. 2 is a schematic view showing how magnetic particles are sorted and detected in the present invention;

FIGS. 3A and 3B are explanatory views each showing a method of sorting magnetic particles in the present invention;

FIG. 4 is an explanatory view showing a method of sorting magnetic particles in the present invention;

FIGS. 5A, 5B, and 5C are views showing a configuration of a sorting apparatus in different stages of operation according to Example 1 of the present invention;

FIGS. 6A, 6B, and 6C are views each showing a configuration of a magnetic particle according to Example 1 of the present invention; and

FIG. 7 is a view showing a configuration of a detection apparatus according to Example 1 of the present invention.

### DESCRIPTION OF THE PREFERRED EMBODIMENTS

Hereinafter, the present invention will be described in detail.

The present invention relates to an apparatus for sorting multiple particles having different properties in a fluid, including: a flow channel for conveying the fluid containing the particles; multiple sorting regions for sorting the particles according to their properties, the sorting regions being present in the flow channel; and sorting means for sorting particles having the same property by utilizing a difference in attraction force caused by a difference in property between particles, the sorting means being placed in each of the sorting regions.

The flow channel preferably further includes at least one branched flow channel for collecting the particles sorted according to their properties. Furthermore, it is preferable that the branched flow channel be present in each of the sorting regions.

The present invention also relates to a method of sorting multiple particles having different properties in a fluid, including: conveying the fluid containing the particles at a constant flow rate; and sorting particles having the same property by utilizing a difference in attraction force caused by a difference in property between particles to thereby sort the particles according to their properties.

The present invention also relates to a reagent for capturing a target substance in a sample, including: multiple kinds of particles having different properties that can be collected according to their different properties; and a capture body for specifically capturing the target substance to the surface of each of the particles, in which the capture body captures a target substance different for each of particles having different properties.

The present invention also relates to an apparatus for detecting multiple target substances in a sample, including: means for causing the reagent for capturing a target substance to capture a target substance in the sample; a flow channel for conveying the reagent and the sample; multiple sorting regions for sorting the particles according to their properties, the sorting regions being present in the flow channel; sorting means for sorting particles having the same property by utilizing a difference in attraction force caused by a difference in property between any two of the particles, the sorting means being placed in each of the sorting regions; and means for detecting the amount of the target substance captured by the reagent for capturing a target substance in each of the sorting regions.

The present invention also relates to a method of detecting multiple target substances in a sample, including: causing the reagent for capturing a target substance to capture a target substance in the sample; fixing particles having different properties in the reagent for capturing a target substance to different sorting regions according to their properties; and detecting the amount of the target substance captured by the reagent for capturing a target substance in each of the sorting regions.

Hereinafter, the best embodiment according to the present invention will be described in detail with reference to accompanying drawings.

The term “particles having different properties” in this embodiment refers to particles each composed of an arbitrary material and affected by fields such as a magnetic field, an electric field, and a gravitational field. Particles to be affected by a magnetic field include magnetic particles, while particles to be affected by an electric field include chargeable particles. In addition, a particle having a mass is affected by a gravitational field, so any particle is actually affected by a certain field.

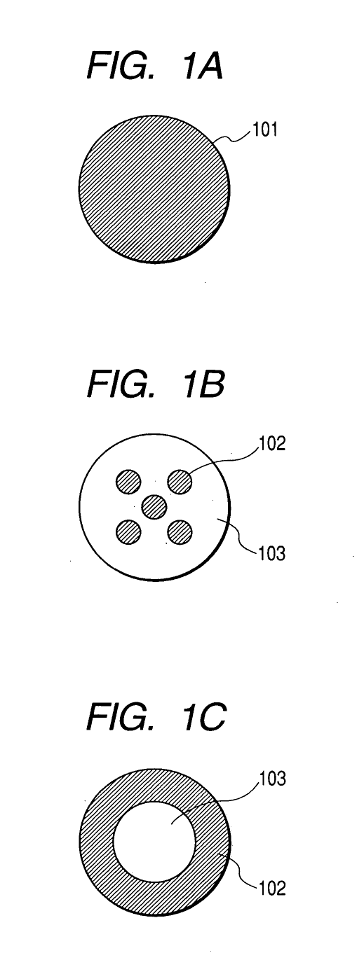

FIGS. 1A to 1C are explanatory views showing magnetic particles to be used in the present invention. FIG. 1A shows a spherical magnetic particle 101. A particle is not necessarily composed a single kind of material as in FIG. 1A irrespective of whatever field the particle is to be affected by. As shown in FIG. 1B, a particle may be constructed in such a manner that the particle contains at least one particle 102 strongly affected by a field, the particle 102 being coated with a particle 103 of a kind different from the particle 102 and hardly affected by a field. Alternatively, as shown in FIG. 1C, a particle may be constructed in such a manner that the particle 102 strongly affected by a field coats the particle 103 of a kind different from the particle 102 and hardly affected by a field. Furthermore, each particle is not necessarily spherical, and may be of a nonuniform shape (not shown) having no steric symmetry. Described here is the case of using particles which are spherical as shown in FIG. 1A and have the same size, but are affected by multiple kinds of fields in different manners because materials different from each other in property are used. In addition, the particles in the present invention include particles each having fixed thereto a capture body having a function of capturing a target substance to a particle containing a material affected by a field.

The flow channel to be used in this embodiment is composed of an arbitrary material, and is not limited as long as the flow channel allows the fluid containing the particles to flow.

In addition, the sorting region refers to a field to which a field is to be applied, and the intensity of the field to be applied is preferably one that can be freely changed.

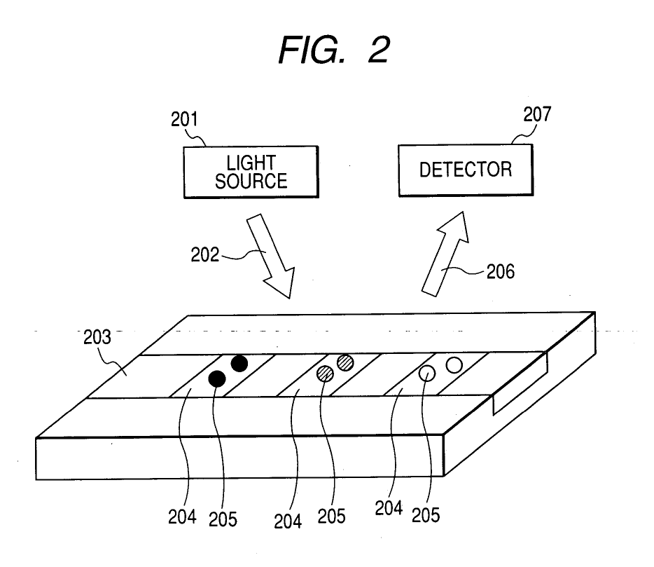

FIG. 2 is a schematic view showing how magnetic particles are sorted and detected. In this embodiment, a light source and a detector necessary for the detection are arranged on one side of a sorting region as shown in FIG. 2. In this case, a cover for a flow channel including the sorting region and the flow channel are each preferably made of a material transparent to light, for example, glass.

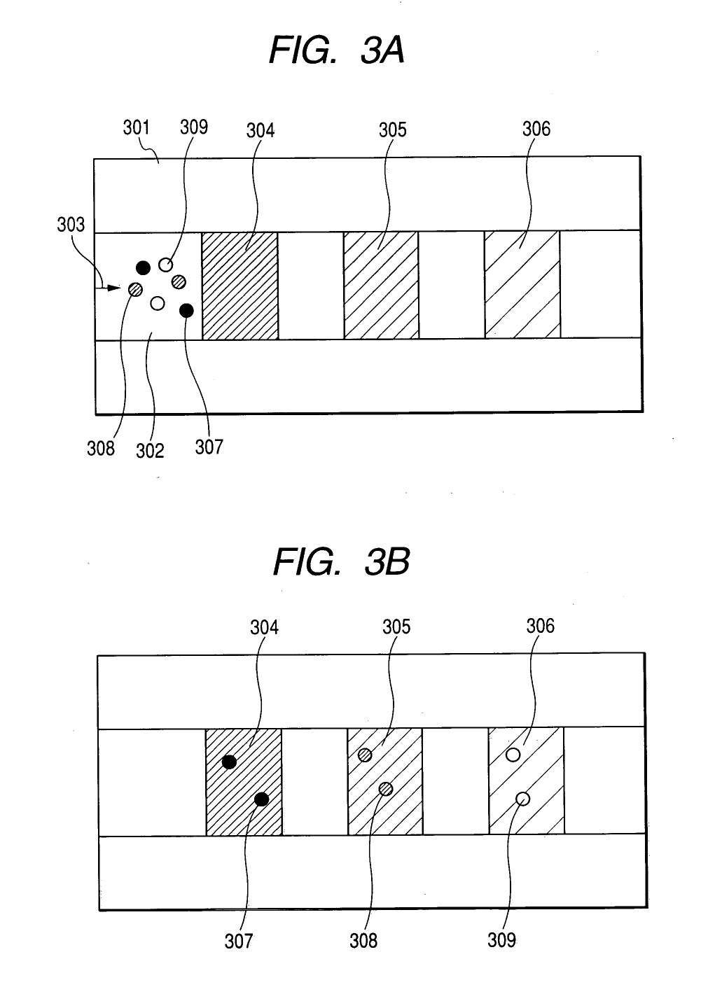

FIG. 2 schematically shows an entire configuration of a sorting apparatus including a detection device, while FIGS. 3A and 3B each schematically show an entire configuration of a flow channel including a sorting region.

A detection system is composed of a light source 201, a flow channel 203, sorting regions 204, particles 205 each of which has captured a target substance, and a detector 207. Light emitted from the light source 201 is incident as incident light 202 on the sorting regions 204 arranged in the flow channel. Before the particles 205 are sorting into the sorting regions 204, each of the particles is allowed to capture a fluorescence-labeled target substance. When light for exciting a fluorescence molecule is incident on the particles 205 each of which has captured the fluorescence-labeled target substance, fluorescence 206 is emitted from each separation region. The fluorescence 206 is detected by the detector 207.

At this time, the light source 201 and the detector 207 are arranged on the same side with respect to the sorting regions 204, but may be arranged on different sides to detect fluorescence.

In this case, a target substance is fluorescence-labeled to emit fluorescence. A detection system that detects light emitted by means of chemiluminescence may also be used.

FIGS. 3A and 3B each show a configuration of a sorting apparatus.

A sorting apparatus 301 is composed of: a flow channel 302; sorting regions 304, 305, and 306; and particles 307, 308, and 309. The sorting regions 304, 305, and 306 are allowed to have field intensities different from one another, and the configurations of the particles 307, 308, and 309 are changed so that the particles are sorting into the sorting regions 304, 305, and 306, respectively.

A fluid in which the particles 307, 308, and 309 are mixed is allowed to flow through the flow channel 302 in the direction of a flow 303. The configurations of the particles 307, 308, and 309 are changed so that the particles are sorted into the sorting regions 304, 305, and 306. As a result, the particles are sorted into the respective regions as shown in FIG. 3B. With the above procedure, multiple particles of multiple kinds can be sorted at one time.

At this time, the field to be applied to the sorting regions is a magnetic field, and the intensity of the magnetic field to be applied gradually increases in order of increasing number of sorting region (that is, 304<305<306). The particles 307, 308, and 309 are magnetic particles, and their susceptibility to the magnetic field decreases in order of increasing number of magnetic particle (that is, 307>308>309). In this way, particles having the same property are sorted by utilizing a difference in attraction force caused by a difference in property between particles, so the particles 307, 308, and 309 are sorted into the sorted regions 304, 305, and 306. The particles and the sorting regions are preferably affected by a magnetic field, but a sorting apparatus in which each of the particles and the sorting regions is affected by a gravitational field or an electric field may also be used.

(Particles)

Particles to be sorted into sorting regions are roughly classified into a magnetic particle, a chargeable particle, and a particle having a mass. Since a particle present in a gravitational field generally has a mass, so the particle may be composed of any material. Materials having different densities are used for varying property with respect to a gravitational field, whereby particles having different properties can be produced.

Magnetic particles are not limited as long as they are each made of a material exhibiting magnetism, but desirably exhibit superparamagnetism, so a general magnetic material may be used. The properties of magnetic particles can be varied by using particles made of different magnetic materials. The properties of magnetic particles can also be varied by: introducing magnetic particles into a material other than any magnetic material as shown in FIG. 1B; and varying the number of the magnetic particles. In addition, in a particle having a structure in which a particle made of a material other than any magnetic material is coated with a magnetic material as shown in FIG. 1C, the size of the particle made of a material other than any magnetic material is varied and the thickness of the coat made of the magnetic material is kept constant, whereby magnetic particles having different properties can be produced.

A chargeable particle may be made of any material as long as the material is chargeable. When properties of chargeable particles are to be varied, chargeable particles having different properties can be produced in the same manner as in magnetic particles.

(Target Substance/Target Substance Capture Body)

Target substances are roughly classified into a biological substance or nonbiological substance.

Examples of a nonbiological substance having great industrial significance include: PCBs with various numbers/positions of substitution of chlorine as an environmental contaminant; dioxins with various numbers/positions of substitution of chlorine; and endocrine disruptors referred to as environmental hormones (such as hexachlorobenzene, pentachlorophenol, 2,4,5-trichloroacetic acid, 2,4-dichlrophenoxyacetic acid, amitrole, atrazine, alachlor, hexachlorocyclohexane, ethylparathion, chlordane, oxychlordane, nonachlor, 1,2-dibromo-3-chloropropane, DDT, kelthane, aldrin, endrin, dieldrin, endosulfan (benzoepin), heptachlor, heptachlor epoxide, malathion, methomyl, methoxychlor, mirex, nitrofen, toxaphene, trifluralin, alkylphenol (5 to 9 carbon atoms), nonylphenol, octynonylphenol, 4-octylphenol, bisphenol A, di-2-ethylhexyl phthalate, butylbenzyl phthalate, di-n-butyl phthalate, dicyclohexyl phthalate, diethyl phthalate, benzo(a)pyrene, 2,4-dichlorophenol, di-2-ethylhexyl adipate, benzophenone, 4-nitrotoluene, octachlorostyrene, aldicarb, benomyl, kepone (chlordecone), manzeb (mancozeb), maneb, metiram, metribuzin, cypermethrin, esfenvalerate, fenvalerate, permethrin, vinclozolin, zineb, ziram, dipentyl phthalate, dihexyl phthalate, and dipropyl phthalate).

Examples of the biological substance include biological substances selected from nucleic acids, proteins, sugar chains, lipids, and complexes thereof. More specifically, the present invention can be applied to any of substances as long as they contain biological substances selected from nucleic acids, proteins, sugar chains, and lipids, and more specifically, contain substances selected from DNA, RNA, aptamers, genes, chromosomes, cell membranes, viruses, antigens, antibodies, lectin, hapten, hormones, receptors, enzymes, peptides, sphingoglycolipid, and sphingolipid. In addition, bacteria and cells themselves that produce the “biological substances” described above can be target substances as the “biological substances” intended by the present invention. Specific examples of the proteins include so-called disease markers.

Examples of the disease markers include: α-fetoprotein (AFP), an acid glycoprotein produced in hepatic cells for a fetal period and present in fetal blood, as a marker for hepatocellular carcinoma (primary liver cancer), hepatoblastoma, metastatic liver cancer, and yolk sac tumor; PIVKA-II, abnormal prothrombin appearing at the time of hepatic parenchymal injury, which is confirmed to specifically appear in hepatocellular carcinoma; BCA225, a glycoprotein that is an antigen immunohistochemically specific for breast cancer, as a marker for advanced primary breast cancer and recurrent/metastatic breast cancer; basic fetoprotein (BFP), a basic fetal protein found in extracts from human fetal serum, intestine, and brain tissue, as a marker for ovarian cancer, testicular tumor, prostatic cancer, pancreatic carcinoma, biliary tract carcinoma, hepatocellular carcinoma, renal cancer, lung cancer, gastric cancer, bladder carcinoma, and colon cancer; a carbohydrate antigen CA15-3 as a marker for advanced breast cancer, recurrent breast cancer, primary breast cancer, and ovarian cancer; a carbohydrate antigen CA19-9 as a marker for pancreatic carcinoma, biliary tract carcinoma, gastric cancer, liver cancer, colon cancer, and ovarian cancer; a carbohydrate antigen CA72-4 as a marker for ovarian cancer, breast cancer, colorectal cancer, gastric cancer, and pancreatic carcinoma; a carbohydrate antigen CA125 as a marker for ovarian cancer (particularly, serous cystadenocarcinoma), adenocarcinoma of the uterine body, cancer of the Fallopian tube, adenocarcinoma of the uterine cervix, pancreatic carcinoma, lung cancer, and colon cancer; a glycoprotein CA130 as a marker for epithelial ovarian cancer, cancer of the Fallopian tube, lung cancer, hepatocellular carcinoma, and pancreatic carcinoma; a core protein antigen CA602 as a marker for ovarian cancer (particularly, serous cystadenocarcinoma), adenocarcinoma of the uterine body, and adenocarcinoma of the uterine cervix; a core carbohydrate-related antigen CA54/61 (CA546) as a marker for ovarian cancer (particularly, mucinous cystadenocarcinoma), adenocarcinoma of the uterine cervix, and adenocarcinoma of the uterine body; a carcinoembryonic antigen (CEA) that has currently been used most widely for assistance in diagnosing cancer as a tumor-associated marker antigen for colon cancer, gastric cancer, rectal cancer, biliary tract carcinoma, pancreatic carcinoma, lung cancer, breast cancer, uterine cancer, and urinary system cancer; a carbohydrate antigen DUPAN-2 as a marker for pancreatic carcinoma, biliary tract carcinoma, hepatocellular carcinoma, gastric cancer, ovarian cancer, and colon cancer; elastase 1, an exocrine pancreatic protease present in the pancreas that specifically hydrolyzes an elastic fiber elastin (composing arterial walls, tendons, and the like) in connective tissue, as a marker for pancreatic carcinoma, cystic carcinoma of the pancreas, and biliary tract carcinoma; an immunosuppressive acidic protein (IAP), a glycoprotein present at high concentrations in the ascites and serum of a human patient with cancer, as a marker for lung cancer, leukemia, cancer of the esophagus, pancreatic carcinoma, ovarian cancer, renal cancer, cholangioma, gastric cancer, bladder carcinoma, colon cancer, thyroid carcinoma, and malignant lymphoma; a carbohydrate antigen NCC-ST-439 as a marker for pancreatic carcinoma, biliary tract carcinoma, breast cancer, colon cancer, hepatocellular carcinoma, adenocarcinoma of the lung, and gastric cancer; a glycoprotein γ-seminoprotein (γ-Sm) as a marker for prostatic cancer; a prostate-specific antigen (PSA), a glycoprotein present only in prostate tissue that is extracted from human prostate tissue, and thus used as a marker for prostatic cancer; prostatic acid phosphatase (PAP), an enzyme that hydrolyzes phosphoric ester at acidic pH secreted from the prostate, used as a tumor marker for prostatic cancer; neuron-specific enolase (NSE), an enzyme in glycolytic pathways that is specifically present in nervous tissue and neuroendocrine cells, as a marker for lung cancer (particularly, small cell carcinoma of the lung), neuroblastoma, nervous system tumor, islet cell cancer, small cell carcinoma of the esophagus, gastric cancer, renal cancer, and breast cancer; a squamous cell carcinoma-related antigen (SCC antigen), a protein that is extracted and purified from the metastatic focus of squamous cell carcinoma of the uterine cervix in the liver, as a marker for uterine cancer (cervical squamous cell carcinoma), lung cancer, cancer of the esophagus, head and neck cancer, and skin cancer; a carbohydrate antigen sialyl Lex-i antigen (SLX) as a marker for adenocarcinoma of the lung, cancer of the esophagus, gastric cancer, colon cancer, rectal cancer, pancreatic carcinoma, ovarian cancer, and uterine cancer; a carbohydrate antigen Span-1 as a marker for pancreatic carcinoma, biliary tract carcinoma, liver cancer, gastric cancer, and colon cancer; a tissue polypeptide antigen (TPA), a single-stranded polypeptide useful for the speculation, prediction of recurrence, and observation of therapeutic process of advanced cancer particularly in combination with other tumor markers, as a marker for cancer of the esophagus, gastric cancer, colorectal cancer, breast cancer, hepatocellular carcinoma, biliary tract carcinoma, pancreatic carcinoma, lung cancer, and uterine cancer; a core carbohydrate antigen sialyl Tn antigen (STN) as a marker for ovarian cancer, metastatic ovarian cancer, gastric cancer, colon cancer, biliary system cancer, pancreatic carcinoma, and lung cancer; cytokeratin (CYFRA) as an effective tumor marker for the detection of non-small cell carcinoma of the lung, particularly squamous cell carcinoma of the lung; pepsinogen (PG), the inactive precursor of two pepsins (PG I and PG II) that are proteases secreted into gastric juice, as a marker for gastric ulcer (particularly, gastric ulcer located in the lower part), gastroduodenal ulcer (particularly, recurrent and intractable cases), Brunner's gland adenoma, Zollinger-Ellison syndrome, and acute gastritis; a C-reactive protein (CRP), an acute phase reactant varying in quantity in plasma by infection and tissue injury, which shows high values when myocardial necrosis is caused by acute myocardial infarction and the like; a serum amyloid A protein (SAA), an acute phase reactant varying in quantity in plasma by tissue injury and infection; myoglobin, a heme protein with a molecular weight of approximately 17,500 that is present mainly in cardiac muscles and skeletal muscles, as a marker for acute myocardial infarction, muscular dystrophy, polymyositis, and dermatomyositis; creatine kinase (CK) (three isozymes of CK-MM type derived from skeletal muscles, CK-BB type derived from brains and smooth muscles, and CK-MB type derived from cardiac muscles, mitochondrial isozyme, and immunoglobulin-linked CK (macro CK)), an enzyme present mainly in the soluble fractions of skeletal muscles and cardiac muscles that emigrates into blood by cell injury, as a marker for acute myocardial infarction, hypothyroidism, progressive muscular dystrophy, and polymyositis; troponin T, a protein with a molecular weight of 39,000 that forms a troponin complex with troponin I and troponin C on the thin filaments of striated muscles and participates in the regulation of muscular contraction, as a marker for rhabdomyolysis, myocarditis, myocardial infarction, and renal failure; ventricular myosin light chain I, a protein contained in the cells of any of skeletal muscles and cardiac muscles, which is used as a marker for acute myocardial infarction, muscular dystrophy, and renal failure because a rise in its measurement means injury and necrosis in skeletal muscles and cardiac muscles; and chromogranin A, thioredoxin, 8-OHdG, and cortisol, which are attracting attention as stress markers in recent years.

An “antibody”, a kind of capture body in the present invention, means immunoglobulin that is produced in the body of an organism in the nature or entirely or partially synthesized by gene recombination techniques and protein engineering techniques as well as organic reactions and the like. All derivatives thereof retaining specific binding ability are also encompassed by the “antibody” in the present invention. This term also includes any protein (including a chimeric antibody and a humanized antibody) having a binding domain homologous or highly homologous to the binding domain of immunoglobulin. Such an “antibody” or “immunoglobulin” is allowed to be produced in the body of an organism in the nature or to be entirely or partially synthesized and modified.

The “antibody” or “immunoglobulin” can be a monoclonal antibody or polyclonal antibody specific for a target substance.

The “antibody” or “immunoglobulin” can be a member of any immunoglobulin class including any human immunoglobulin class (IgG, IgM, IgA, IgD, and IgE) and more preferably, a derivative of IgG class in the present invention.

An “antibody fragment” in the present invention refers to any antibody molecule or complex smaller than the full length of the antibody or immunoglobulin described above. Preferably, the antibody fragment retains at least the critical portion of the specific binding ability of the antibody having full length. Examples of the antibody fragment include, but not limited to, Fab, Fab′, F(ab′)2, scFv, Fv, diabody, and Fd fragments.

The antibody fragment can be produced by any means. For example, the antibody fragment can be enzymatically or chemically produced by the fragmentation of an intact antibody, or can be recombinantly produced with a gene encoding a partial antibody sequence. Alternatively, the antibody fragment can be entirely or partially produced in a synthetic manner. The antibody fragment can be a single-stranded antibody fragment, if necessary. Alternatively, the antibody fragment can contain multiple chains linked through, for example, a disulfide (—S—S—) bond. The antibody fragment may also be a complex of multiple molecules, if necessary. A functional antibody fragment typically contains at least approximately 50 amino acids, more typically at least approximately 200 amino acids.

A “variable domain” in the present invention refers to a domain at the end of immunoglobulin (usually described as “Fv”) that contains an amino acid sequence portion varying depending on each antigen in order to exert a specific binding/capture function according to the type of a target substance (antigen).

The above-described Fv is composed of “the variable domain of a heavy chain (hereinafter, also referred to as “VH”)” and “the variable domain of a light chain (hereinafter, also referred to as “VL”)” and immunoglobulin G usually contains two VH domains and two VL domains.

The “functional portion of the variable domain of immunoglobulin heavy chain or light chain (hereinafter, also referred to as a “functional portion” simply)” in the present invention is a portion actually responsible for specificity for a target substance (antigen) in the variable domain described above and is also used for referring to a portion academically designated as complementarity determining region (CDR: hypervariable region) and particularly a portion actually responsible for specificity for a target substance (antigen) in the CDR.

Interaction between a target substance and the capture body may be any interaction as long as its physical/chemical variation before and after binding is detectable by the particles of the present invention. However, preferable examples of the interaction include “antigen-antibody reaction”, “antigen-aptamer (RNA fragment having a particular structure) interaction”, “ligand-receptor interaction”, “DNA hybridization”, “DNA-protein (e.g., transcription factor) interaction”, and “lectin-sugar chain interaction”.

Here, one having a capture body for specifically capturing the target substance to a surface of each of the particles, the capture body capturing a target substance different for each of particles having different properties is defined as a reagent for capturing a target substance.

In addition, by using, for detecting a target substance, a kit for detecting a target substance, the kit including at least: a reagent for capturing a target substance; and a capture body for recognizing the target substance with a label that can be optically detected, the target substance can be easily detected when the detection apparatus of the present invention is used. The term “kit for detecting a target substance” as used herein refers to a combination of a reagent for capturing a target substance and a capture body for recognizing a target substance with a label that can be optically detected.

(Flow Channel)

The flow channel of the present invention may be processed as a fine groove on a substrate, and may have a capillary structure.

Any material can be used for constituting the flow channel of the present invention as long as the flow channel can be processed from the material, a sample can be introduced into a sorting region, and the material does not inhibit a detection system. However, for example, the flow channel to be used is generally obtained by: processing an inorganic material such as glass, quartz glass, or silicon, or a resin such as polymethyl methacrylate (PMMA) or polydimethylsiloxane (PDMS); and joining the processed product as required, or is obtained by processing glass, polyimide, fumed silica, or the like as a capillary.

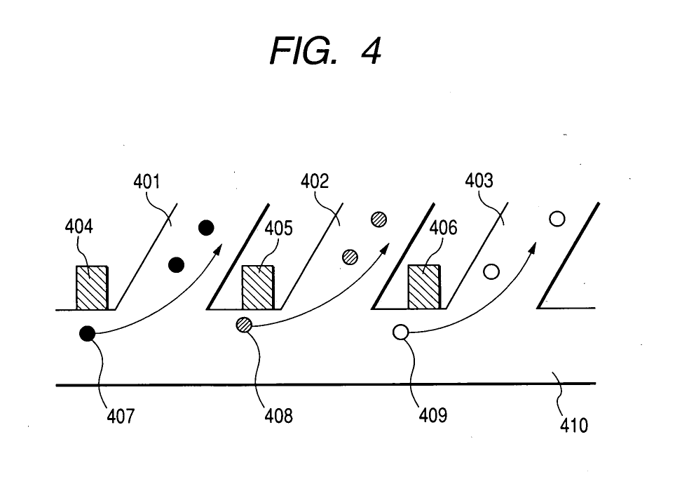

Alternatively, as shown in FIG. 4, a flow channel 410 is provided with branched flow channels 401, 402, and 403, and sorting means 404, 405, and 406 are placed in immediate front of the respective branched flow channels. In this case, particles 407, 408, and 409 are attracted to the branched paths 401, 402, and 403 respectively by attraction force generated by a field, so the particles can be sorted according to their properties.

Hereinafter, the present invention will be described by way of other examples. However, the examples do not limit the scope of the present invention at all.

### Example 1

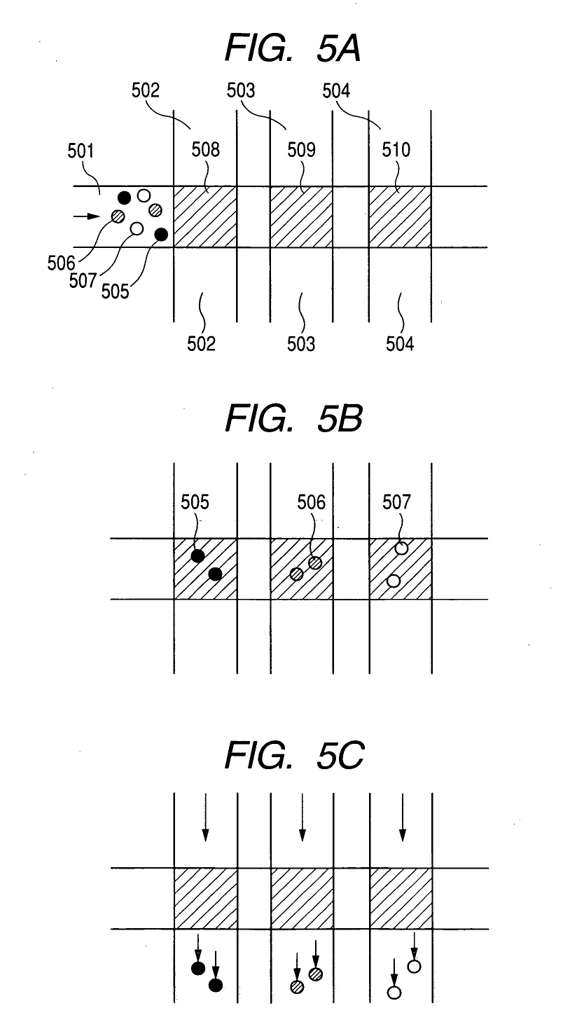

First, Example 1 will be described with reference to FIGS. 5A to 5C.

FIGS. 5A to 5C are schematic diagrams of this example. A sorting apparatus shown in FIG. 5A is composed of: flow channels 501, 502, 503, and 504; magnetic particles 505, 506, and 507; and sorting regions 508, 509, and 510. Each of the flow channels is provided with an inlet port into which a fluid containing the magnetic particles 505, 506, and 507 flows and an outlet port for discharging the fluid containing the magnetic particles 505, 506, and 507 after sorting of various magnetic particles, although the ports are not shown here. In addition, each of the magnetic particles has fixed thereto a capture body for capturing a target substance, and a reaction with a target substance is carried out before the fluid flows into the flow channels.

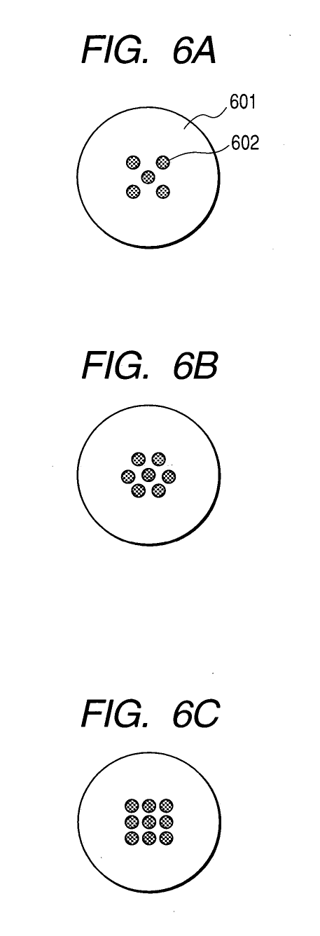

A magnetic particle having fixed thereto a capture body will be described here. In this example, a magnetic microsphere manufactured by Merck as shown in each of FIGS. 6A to 6C is used as a magnetic particle. The magnetic particle is structured in such a manner that ferrites 602 are present in the particle and are coated with a polystyrene 601. The magnetic particle has a size of 0.9 μm to 1.8 μm. In FIGS. 6A to 6C, the ferrite contents are 15 to 25%, 26 to 35%, and 36 to 50%, respectively. FIGS. 6A to 6C correspond to the magnetic particles 507, 506, and 505 in FIGS. 5A to 5C, respectively. A carboxyl group is fixed to the surface of each of those magnetic particles. Each of the magnetic particles is allowed to have fixed thereto streptavidin according to the following procedure for fixing a biotin-modified anti-CEA antibody, anti-AFP antibody, or anti-PSA antibody as a capture body.

An aqueous solution of N-hydroxysulfosuccinimide (manufactured by Dojin Kagaku Laboratories) and an aqueous solution of 1-ethyl-3-[3-dimethylaminoproply]carbodiimide hydrochloride (manufactured by Dojin Kagaku Laboratories) are dropped onto each magnetic particle by means of a spotter. As a result, a succinimide group is exposed to the surface of the magnetic particle. Furthermore, streptavidin is bound with the surface of the magnetic particle, whereby the surface of the magnetic particle is modified by streptavidin.

Finally, a biotin-modified anti-CEA antibody, anti-AFP antibody, or anti-PSA antibody is adsorbed, whereby a reagent for capturing a target substance in the present invention is prepared.

In actual measurement, attempts are made to detect various antigens of CEA, AFP, and PSA known as cancer markers. Various antigens each labeled with a fluorescent dye (Cy5) are adsorbed according to the following procedure.
(1) Three kinds of antibodies each fluorescence-labeled with a Cy5 dye are introduced into 3 kinds of biotin-modified antibodies, and the whole is incubated for 5 minutes.
(2) The labeled antibodies are sampled and washed with a phosphate buffer.
(3) A sample in which a CEA antigen, a PSA antigen, and an AFP antigen are mixed is introduced into 3 kinds of biotin-modified antibodies, and the whole is incubated for 5 minutes.
(4) An antigen solution is sampled and washed with a phosphate buffer.
(5) The labeled antibodies are introduced into a flow channel and incubated for 5 minutes.
(6) The labeled antibodies are sampled and washed with a phosphate buffer.

The streptavidin-modified magnetic particles shown in FIGS. 6A to 6C are allowed to adsorb the biotin-modified anti-CEA, anti-AFP, and anti-PSA antibodies to prepare the reagent for capturing a target substance. Each of the reagent and various antigens of CEA, AFP, and PSA labeled with a fluorescent dye (Cy5) is adsorbed. A fluid containing those complex magnetic particles is introduced from an inlet port and is allowed to flow in the direction indicated by an arrow of FIG. 5A. A magnetic field is applied to the sorting regions 508, 509, and 510, and the intensity of the magnetic field is adapted to gradually increase in order of increasing number of separation region (that is, 508<509<510). As a result, as shown in FIG. 5B, the magnetic particles 505, 506, and 507 are separated into the separation regions 508, 509, and 510. Furthermore, the flow in the direction in which the fluid is allowed to flow in FIG. 5A is stopped, and, as shown in FIG. 5C, a fluid is allowed to flow in each of the flow channels 502, 503, and 504 in the direction indicated by an arrow. After that, the magnetic field applied to the sorting regions 508, 509, and 510 is removed. Thus, the magnetic particles 505, 506, and 507 that have been sorted into the sorting regions 508, 509, and 510 flow in the directions of the flow channels 502, 503, and 504 indicated by arrows, respectively, followed by being collected at respective outlet ports.

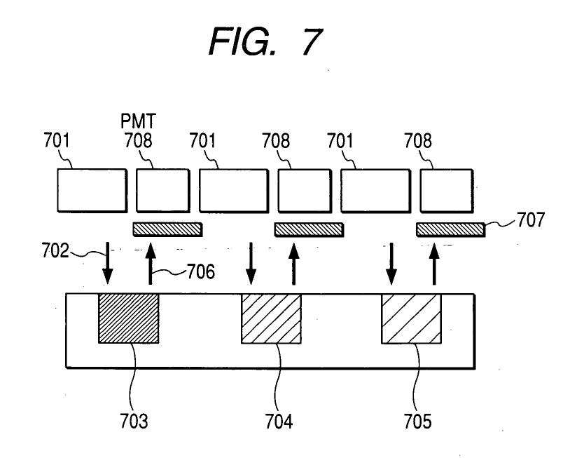

After the collection, the capture by each magnetic particle of a fluorescence-labeled target substance is detected by using a detection apparatus shown in FIG. 7. First, a laser diode 701 is used as a light source, and a fluid containing the collected respective particles is injected into each of containers 703, 704, and 705. Excitation light 702 from the laser diode 701 excites the fluorescent dye (Cy5) of the magnetic particles each labeled with the fluorescent dye in the containers 703, 704, and 705, so fluorescence 706 is emitted from each container. The fluorescence 706 emitted from each container passes through a filter 707 to be detected by a photoelectric multiplier (PMT) 708.

The apparatus for sorting particles of the present invention is provided with multiple sorting regions, so it is capable of sorting multiple particles of a specific kind at one time from multiple kinds of particles in a fluid. In addition, the apparatus for sorting particles can be used for an apparatus for detecting a target substance that detects whether a target substance different for each kind of particles having different properties is captured by providing a particle to be separated with a capture body that specifically captures a target substance.

This application claims priority from Japanese Patent Application No. 2004-190302 filed Jun. 28, 2004, which is hereby incorporated by reference herein.

1. An apparatus for sorting particles of multiple kinds having different properties in a fluid, comprising:
a flow channel for conveying the fluid containing the particles;
multiple sorting regions provided in the flow channel for sorting the particles according to their properties; and
sorting means provided in each of the sorting regions, the sorting means being capable of sorting particles having the same property by utilizing a difference in attraction force caused by a difference in property between particles.

2. An apparatus for sorting particles according to claim 1, wherein the particles comprise magnetic particles.

3. An apparatus for sorting particles according to claim 1, further comprising at least one branched flow channel for collecting the particles sorted according to their properties in the sorting regions.

4. An apparatus for sorting particles according to claim 3, wherein the branched flow channel is provided in each of the sorting regions.

5. A reagent for capturing a target substance in a sample, comprising:
multiple kinds of particles that can be collected according to their different properties; and
a capture body fixed on each surface of the particles for specifically capturing the target substance, wherein the capture body is capable of capturing a target substance specific for each of the multiple kinds having different properties.

6. A kit for detecting a target substance in a sample, comprising at least:
the reagent for capturing a target substance according to claim 5; and
a capture body for recognizing the target substance with a label that can be optically detected.

7. An apparatus for detecting multiple target substances in a sample, comprising:
means for causing the reagent for capturing a target substance according to claim 5 to capture a target substance in the sample;
a flow channel for conveying the reagent and the sample;
multiple sorting regions provided in the flow channel for sorting the particles according to their properties;
sorting means provided in each of the sorting regions, the sorting means being capable of sorting particles having the same property by utilizing a difference in attraction force caused by a difference in property between particles; and
means for detecting an amount of the target substance captured by the reagent for capturing a target substance in each of the sorting regions.

8. A method of detecting multiple target substances in a sample, comprising:
causing the reagent for capturing a target substance according to claim 5 to capture a target substance in the sample;
fixing particles having different properties in the reagent for capturing a target substance to different sorting regions according to their properties; and
detecting an amount of the target substance captured by the reagent for capturing a target substance in each of the sorting regions.

9. A method of sorting multiple particles having different properties in a fluid, comprising:
conveying the fluid containing the particles at a constant flow rate; and
sorting particles having the same property by utilizing a difference in attraction force caused by a difference in property between particles to thereby sort the particles according to their properties.
